(19) United States
(12) Patent Application Publication
(10) Pub. No.: US 2026/0135882 A1
(43) Pub. Date: May 14, 2026

(54) METHOD TO DETECT AND PREVENT CALLBACK PHISHING

(71) Applicant: Cisco Technology, Inc., San Jose, CA (US)

(72) Inventor: Suresh Gopathy, Alpharetta, GA (US)

(21) Appl. No.: 18/945,263

(22) Filed: Nov. 12, 2024

(51) Int. Cl. H04L 9/40; H04L 51/212

(52) U.S. Cl. CPC H04L 63/1483; H04L 51/212

(57) ABSTRACT

This disclosure describes techniques for an email security system to detect and prevent callback phishing attacks included within electronic messages. An email security system may receive an email that is to be delivered to a receiving user. Based on the email metadata, the email security system may determine an intent associated with the email (e.g., whether the email is malicious). In some instances, the email may be associated with an indication of a phone number. Based on the metadata associated with the phone number, the email security system may be configured to determine a reputation associated with the phone number. The email security system may then use the reputation and/or the intent to determine whether the email is associated with a callback phishing attempt. The email security system may then determine whether to transmit the email to the receiving user, or perform a remedial action regarding the email.

### TECHNICAL FIELD

The present disclosure relates generally to techniques for an email security system to detect and prevent callback phishing attacks included within electronic messages.

### BACKGROUND

Electronic messages and mail, or “email,” continue to be a primary method of exchanging messages between users of electronic devices. Many email service providers have emerged that provide users with a variety of email platforms to facilitate the communication of emails via email servers that accept, forward, deliver, and store messages for the users. Email continues to be a fundamental method of communication between users of electronic devices as email provides users with a cheap, fast, accessible, efficient, and effective way to transmit all kinds of electronic data. Email is well established as a means of day-to-day, private communication for business communications, marketing communications, social communications, educational communications, and many other types of communications.

Due to the widespread use and necessity of email, hackers and other malicious entities use email as a primary channel for delivering different types of attacks. For example, email and/or electronic messages may include attempts for phishing (e.g., the act of attempting to acquire information from users, such as usernames, passwords, or payment information, by posing as a trustworthy entity, colleague, etc. in a message). In another example, email and/or electronic messages may include malware (e.g., software intentionally designed to cause damage to an electronic device) may be sent to the electronic device using messages. Often times, these attacks are performed using uniform resource locators (URLs) that are included within an email. Additionally, email and/or electronic messages may include attempts for callback phishing, where an email may include a phone number for a receiving user to call while the malicious sender poses as a legitimate source (e.g., healthcare organization, government agency, bank, etc.), and uses social engineering techniques to obtain phishing information while on a call with the receiving user.

In some instances, cloud messaging services provide secure email gateways (SEGs) that monitor emails for malicious content and implement pre-delivery protection by blocking email-based threats before they reach a mail server. These SEGs can scan incoming, outgoing, and internal communications for signs of malicious or harmful content. However, once the receiving user of a callback phishing email engages in a telephone call with a malicious sender, the telephone call is outside the scope of SEG protection.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example environment in which an email security system detects callback phishing in incoming emails, and processes the emails accordingly.

FIG. 2 illustrates a diagram of example components of the email security system.

FIG. 3 illustrates a flow diagram of an example process for determining email intent and phone number reputation for a phone number included in the email.

FIG. 4 illustrates an example environment in which the email security system uses email intent and phone number reputation to detect callback phishing in incoming emails.

FIG. 5 illustrates a flow diagram of an example process for detecting callback phishing in incoming emails.

FIG. 6 illustrates a computing system diagram illustrating a configuration for a data center that can be utilized to implement aspects of the technologies disclosed herein.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### OVERVIEW

This disclosure describes techniques for detecting and preventing callback phishing in incoming emails based at least in part on a phone number reputation included in the email. A method to perform the techniques described herein includes receiving, at a secure email gateway, an email to be processed and delivered to a user account of an email service, wherein the email is associated with an indication of a phone number. The method further includes determining, based at least in part on first metadata extracted from the email, an intent associated with the email, and receiving, at the secure email gateway, second metadata associated with the phone number. Additionally, the method includes determining, based at least in part on the second metadata, a reputation associated with the phone number, and determining, based at least in part on the intent and the reputation, whether there is an association between the email and a callback phishing attempt. Further, the method includes processing, by the secure email gateway, the email based at least in part on the association between the email and the callback phishing attempt.

Additionally, the techniques described herein may be performed by a system and/or device having non-transitory computer-readable media storing computer-executable instructions that, when executed by one or more processors, performs the method described above.

### EXAMPLE EMBODIMENTS

Various implementations of the present disclosure provide techniques for detecting and preventing callback phishing in incoming emails based at least in part on a phone number reputation included in the email. As discussed above, due to the widespread use and necessity of email, hackers and other malicious entities use email as a primary channel for delivering different types of attacks. For example, email and/or electronic messages may include attempts for phishing (e.g., the act of attempting to acquire information from users, such as usernames, passwords, or payment information, by acting as a trustworthy entity in a message). Related to phishing attempts include callback phishing, where an email may include a phone number for a receiving user to call while the malicious sender poses as a legitimate source (e.g., healthcare organization, government agency, bank, etc.), and uses social engineering techniques to obtain phishing information while on a call with the receiving user.

While secure email gateways (SEGs) may monitor emails for malicious content and implement pre-delivery protection by blocking email-based threats before they reach a mail server, once the receiving user of a callback phishing email engages in a telephone call with a malicious sender, the telephone call is outside the scope of the SEG protection. Additionally, SEGs are unable to convict an incoming email as being associated with callback phishing due to a high false positive rate associated with callback phishing (e.g., an incoming email with a callback phone number may be associated with a genuine entity).

Accordingly, a need exists for systems and methods enabling an intelligent way to configure an email security system (e.g., SEG) to determine a reputation associated with a phone number included in an email, where the reputation may be used along with email intent determinations to classify an email as being associated with a callback phishing attempt.

According to the techniques described herein, an email security system may receive an email that is to be delivered to a receiving user of an email service platform. The email security platform may extract metadata from the email, such as the subject of the email, contents of the email, sender information, etc. Based on the email metadata, the email security system may determine an intent associated with the email (e.g., whether the email is malicious). In some instances, the email may include an indication of a phone number, with instructions requesting that the receiving user call the phone number to engage regarding the subject matter of the email. In some instances, the phone number may be included within the body of the email, an attachment to the email, URLs included with the email, and/or the like. Further, the email security system may extract and/or receive metadata associated with the phone number. For example, the metadata associated with the phone number may include a call history associated with the phone number (e.g., whether the phone number engages in a large volume of calls), user feedback regarding the phone number, and/or the like.

Based on the metadata associated with the phone number, the email security system may be configured to determine and/or identify a reputation associated with the phone number (e.g., a reputation score, a result based on the reputation score, categorization of phone number, etc.). The email security system may then use the reputation and/or the intent to determine whether the email is associated with a callback phishing attempt and/or a malicious email. Based on an association with a callback phishing attempt, or lack thereof, the email security system may determine whether to transmit the email to the receiving user, or perform a remedial action regarding the email (e.g., quarantine the email). In this way, the email security system is able to classify emails as including a callback phishing attempt, and prevent potential malicious attacks on users, with high confidence. Additionally, the determination of a reputation of a phone number included in a malicious email may enable the email security system to rely less on the intent associated with the email, and thus require fewer instances of computing resources (e.g., CPU, GPU, RAM, etc.) and/or computing power to determine intent.

As described herein, the term “malicious” may be applied to data, actions, attackers, entities, emails, etc., and the term “malicious” may generally correspond to spam, phishing, callback phishing, spoofing, malware, viruses, and/or any other type of data, entities, or actions that may be considered or viewed as unwanted, negative, harmful, etc. for a recipient user and/or destination email address associated with an email communication.

To implement the techniques described herein, an email service platform may use, or work in combination with, an email security system. The email security system (e.g., a SEG), may receive, or intercept, emails and/or other types of electronic communications that are to be communicated to users of the email service platform, such as being stored at a location that is accessible to the users via their respective inboxes. After receiving an email for a user (e.g., a receiving user) of the email service platform, the email security system may be configured to extract email metadata associated with the email. Email metadata may include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine the intent of the email (e.g., whether the intent is malicious).

The email security system may be configured to determine the intent of an incoming email based on the email metadata, and in turn, whether the email is potentially malicious. The email metadata may be processed using security analysis techniques to determine whether the email is a scam email, phishing email, and/or other malicious email (e.g., the intent). For example, the email security system may determine that the email was sent from an email address associated with a malicious domain, the subject includes words commonly associated with phishing, spam, and/or spoofing attacks, URLs included in the email are to malicious websites, hashes of attachments correspond to malware attacks, and so forth. The determination of the intent of the email may be represented as a general result (e.g., potentially malicious, safe, unknown, etc.), a probability score indicative of a likelihood of a malicious intent, and/or the like.

In some examples, the email received, or intercepted, by the email security system may be designed to engage the receiving user in a callback phishing attack. In other words, the email may include an indication of a phone number, with instructions for the receiving user to call and/or engage with the phone number. For instance, the email may include a request for a gift card code, wire transfer, and/or salary deposit, a notification regarding a bank account transaction, a list of unpaid invoices, sensitive information, and/or the like. Further, the email may include, along with the request, notification, etc., an indication of the phone number for the user to engage with. For example, the email may appear to be from the receiving user’s bank, include a notification that a certain amount of funds is going to be withdrawn from a user account, as well as a phone number to call if the withdrawal is an error. In some instances, the phone number may be included within the body of the email, an attachment to the email, URLs included with the email, and/or the like.

Additionally, or alternatively, the email security system may be configured to receive and/or extract metadata associated with the phone number (e.g., reputation data). In some examples, the phone number metadata may be received and/or extracted from one or more sources. In some examples, where the phone number metadata is from multiple sources, the phone number metadata may be aggregated and stored at a single location (e.g., a datastore). The phone number metadata may include a call history associated with the phone number (e.g., whether the phone number engages in a large volume of calls), user feedback regarding the phone number, public forums, and/or the like. Based on the phone number metadata, the email security system may be configured to determine, and/or identify, a reputation associated with the phone number included in the email. For example, based on the phone number metadata, the email security system may determine and/or identify a reputation score. For example, the reputation score may be on a scale of -10 to 10, with -10 indicating a negative reputation and 10 indicating a positive reputation. Additionally, or alternatively, based on the phone number metadata and/or the reputation score, the email security system may determine a result based on the reputation score. By way of example, and not limitation, reputation scores between -10 and -6 may be associated with a result of “untrusted,” reputation scores between -5 and 0 may be associated with a result of “suspicious,” reputation scores between 1 and 3 may be associated with a result of “questionable,” reputation scores between 4 and 7 may be associated with a result of “neutral,” and/or reputation scores between 8 and 10 may be associated with a result of “trusted.” However, in other examples, the upper and/or lower bounds for each of the described score ranges could be higher or lower, and/or the score ranges may be larger or smaller. Additionally, or alternatively, based on the phone number metadata, the email security system may determine a categorization and/or classification associated with the phone number. The categorization and/or classification may be based on a threat type associated with the phone number. For example, the categorization and/or classification may indicate that the phone number is associated with a known spamming company trying to get information, a marketing company sending a large amounts of market materials, malicious attackers, and/or the like.

Upon the determination of the reputation associated with the phone number included in the email, the email security system may be configured to classify the email as a non-callback phishing attempt email or a callback phishing attempt email. For example, the email security system may determine that an email is associated with a malicious intent (e.g., the email is sent from a fake address associated with an IP address in a high-risk geographic location). Additionally, or alternatively, the email security system may determine that the email is associated with a reputation score of -10 and indicating an “untrusted” result. Accordingly, the email security system may classify the email as a callback phishing attempt email. In another example, the email security system may determine that the email is not associated with a malicious intent (e.g., the email is sent from a legitimate address associated with a trusted IP address). Additionally, or alternatively, the email security system may determine that the email is associated with a reputation score of 10 and indicating a “trusted” result. Accordingly, the email security system may classify the email as a non-callback phishing attempt email.

The determined email intent and/or phone number reputation may be equally weighted or have differing weights when factored together to determine whether to classify the email as a non-callback phishing attempt email or a callback phishing attempt email. For example, despite a lack of a determination of malicious intent associated with the email by the email security system, the email security system may still classify the email as a callback phishing attempt email based on the reputation.

Based on the classification of the email (e.g., whether the email is a non-callback phishing attempt email or a callback phishing attempt email), the email security system may process the incoming email accordingly. For example, in instances where the email is a non-callback phishing attempt email, the email security system may be configured to forward and/or transmit the email to a receiving user such that the email is delivered to the receiving user’s inbox. In another example, in instances where the email is a callback phishing attempt email, the email security system may be configured to perform a remedial action with respect to the callback phishing attempt email. Remedial actions may include quarantining, flagging, deleting, and/or dropping the callback phishing attempt email, preventing further communication received from the sender and/or further communication sharing similarities with the callback phishing attempt email, blocking and/or flagging the callback phishing attempt email, reporting sender information and/or the phone number to authorities, and/or the like.

The techniques described herein improve the function of email security systems. For example, while secure email gateways (SEGs) may monitor emails for malicious content and implement pre-delivery protection by blocking email-based threats before they reach a mail server, once the receiving user of a callback phishing email engages in a telephone call with a malicious sender, the telephone call is outside the scope of the SEG protection. Additionally, SEGs are unable to convict an incoming email as being associated with callback phishing due to a high false positive rate associated with callback phishing (e.g., an incoming email with a callback phone number may be associated with a genuine entity).

Accordingly, the techniques described herein may increase efficiencies around the detection and prevention of callback phishing attacks in emails and/or other electronic communications, and thus preventing disastrous implications for individuals, enterprises, businesses, and/or the like (e.g., financial loss, emotional damage, etc.). Additionally, the determination and use of a phone number reputation may improve the utilization of computing resources, reduce the number of necessary VM instances to be spun up to determine email intent, and thus reduce customer costs.

Some of the techniques described herein are with reference to callback phishing emails. However, the techniques are generally applicable to any type of malicious email. Additionally, or alternatively, the techniques described herein are with reference to a network, such as a cloud provider network or platform, and networks such as VPCs, subnetworks (or “subnets”). However, the techniques are equally applicable to any network and in any environment. For example, the email security system may monitor an on-premises network.

Various implementations of the present disclosure will be described in detail with reference to the drawings, wherein like reference numerals present like parts and assemblies throughout the several views. Additionally, any samples set forth in this specification are not intended to be limiting and merely demonstrate some of the many possible implementations.

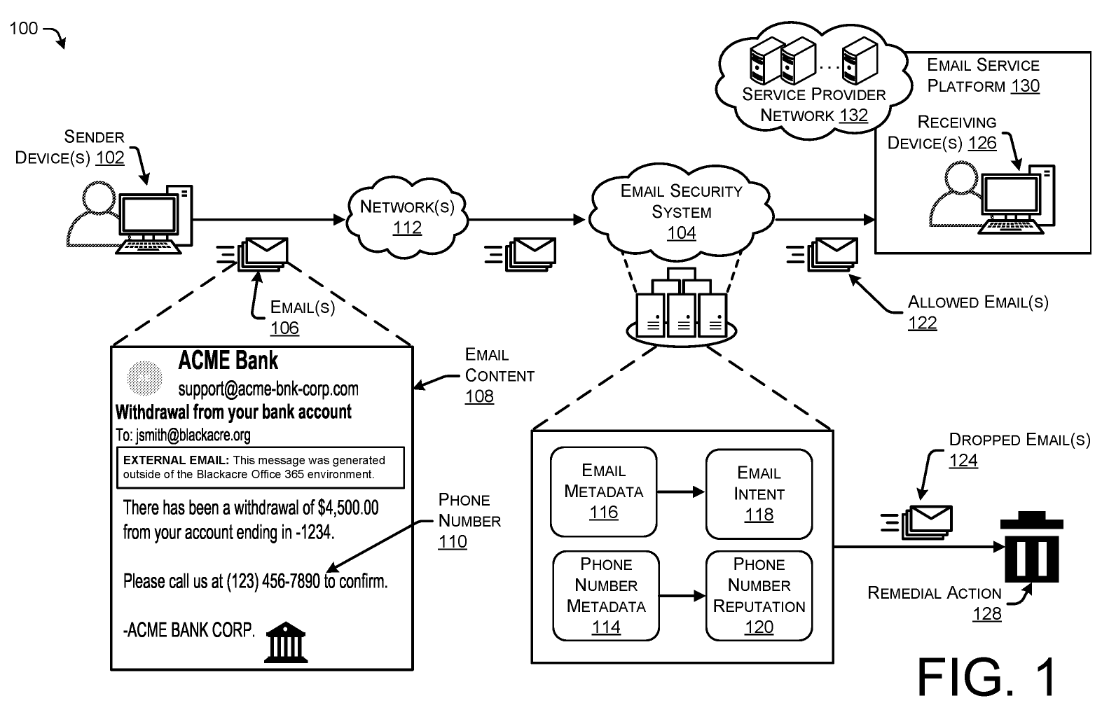

FIG. 1 illustrates an example environment 100 in which an email security system 104 detects callback phishing in incoming emails 106 intended for users of receiving device(s) 126 of an email service platform 130, and processes the emails 106 accordingly.

In some examples, an email service platform 130 may be at a service provider network 132. The service provider network 132 may be or comprise a cloud provider network. A cloud provider network (sometimes referred to simply as a “cloud”) refers to a pool of network-accessible computing resources (such as compute, storage, and networking resources, applications, and services), which may be virtualized or bare-metal. The cloud can provide convenient, on-demand network access to a shared pool of configurable computing resources that can be programmatically provisioned and released in response to user commands. In other instances, however, the service provider network 132 may be an on-premises network, a private network of a corporation, and/or any other type of network or combination thereof.

Additionally, or alternatively, the email service platform 130 may use, or work in combination with, the email security system 104. The email security system 104 may be a scalable system that includes and/or runs on devices housed or located in one or more data centers, that may be located at different physical locations. In some examples, the email security system 104 may be included in the email service platform 130 and/or associated with a secure email gateway (SEG). The email security system 104 and the email service platform 130 may be supported by networks of devices in a public cloud computing platform, a private/enterprise computing platform, and/or any combination thereof. The one or more data centers may be physical facilities or buildings located across geographic areas that are designated to store network devices that are part of and/or support the email security system 104. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as process (CPU), memory (RAM), storage (disk), and networking (bandwidth).

The email security system 104 may be associated with the email service platform 130 of an email service provider, and may generally comprise any type of email and/or service provided by any provider, including public messaging service providers (e.g., Google Gmail, Microsoft Outlook, Yahoo! Mail, etc.), as well as private messaging service platforms maintained and/or operated by a private entity or enterprise. Further, the email service platform 130 may comprise cloud-based messaging service platforms (e.g., Google G Suite, Microsoft Office 365, etc.) that host messaging services. However, the email service platform 130 may generally comprise any type of platform for managing communication between clients or users, such as an email platform, a simple messaging service (SMS) platform, an audio/video communication platform, and so forth. The email service platform 130 may generally comprise a delivery engine behind email communications and include the requisite software and hardware for delivering email communications between users. For instance, an entity may operate and maintain the software and/or hardware of the email service platform 130 to allow users to send and receive emails, store and review emails in inboxes, manage and segment contact lists, build email templates, manage and modify inboxes and folders, scheduling, and/or any other operations performed using the email service platform 130.

The email service platform 130 may provide one or more messaging services to users of receiving device(s) 126 (or any type of user device) to enable the receiving device(s) 126 to communicate and/or receive emails. Sender device(s) 102 may communicate with receiving device(s) 126 over network(s) 112, such as the Internet. In some instances, the network(s) 112 may generally comprise one or more networks implemented by any viable communication technology, such as wired and/or wireless modalities and/or technologies. The network(s) 112 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs) - both centralized and/or distributed - and/or any combination, permutation, and/or aggregation thereof. The network(s) 112 may include devices, virtual resources, or other nodes that relay packets from one device to another.

User devices, such as the sender device(s) 102 that send emails 106 and the receiving device(s) 126 that receive the emails (e.g., allowed emails 122), may comprise any type of electronic device capable of communicating using email communications. For instance, the devices 102/126 may include one or more of different personal user devices, such as desktop computers, laptop computers, phones, tablets, wearable devices, entertainment devices such as televisions, and/or any other type of computing device. Thus, the devices 102/126 may utilize the email service platform 130 to communicate using emails based on email address domain name systems according to techniques known in the art.

As illustrated, the email security system 104 (e.g., a SEG), may receive, or intercept, emails 106 and/or other types of electronic communications that are to be communicated to receiving device(s) 126 of an email service platform 130 from sender device(s) 102, such as being stored at a location that is accessible to the users via their respective inboxes. After receiving an email for a user (e.g., a receiving device(s) 126) of the email service platform 130, the email security system 104 may be configured to extract email metadata 116 associated with email content 108 of the email 106. Email metadata 116 may include, for example, indications of email content 108 such as “From-Field” addresses and/or names for the email, “To-Field” addresses for the email 106, a “Subject” of the email 106, a Date/Time the email 106 was communicated, hashes of attachments to the email 106, URLs in the body of the email 106, Internet Protocol (IP) addresses associated with the email 106, and/or a domain associated with the email 106 (e.g., the email server associated with an email address). In some instances, the metadata may additionally, or alternatively, include content included in the body of the email 106, actual attachments to the email 106, and/or other data of the email 106. Further, the metadata extracted from the email 106 may generally be any probative information for the email security system 104 to determine the intent 118 of the email (e.g., whether the intent is malicious). As illustrated in FIG. 1, the email metadata 116 may indicate email content 108 of the email 106 including the email address of support@acme-bnk-corp.com, the name of “ACME bank,” an indication that the email 106 is an external email, the subject of “Withdrawal from your bank account,” and/or the like.

The email security system 104 may be configured to determine the intent 118 of the incoming email 106 based on the email metadata 116, and in turn, whether the email is potentially malicious. The email metadata 116 may be processed using security analysis techniques to determine whether the email 106 is a scam email, phishing email, and/or other malicious email (e.g., the email intent 118). For example, the email security system 104 may determine that the email 106 was sent from an email address associated with a malicious domain, the subject includes words commonly associated with phishing, spam, and/or spoofing attacks, URLs included in the email 106 are to malicious websites, hashes of attachments correspond to malware attacks, and so forth. The determination of the email intent 118 may be represented as a general result (e.g., potentially malicious, safe, unknown, etc.), a probability score indicative of a likelihood of a malicious intent, and/or the like.

In some examples, the email 106 from sender device(s) 102 received, or intercepted, by the email security system 104 may be designed to engage the receiving device(s) 126 in a callback phishing attack. In other words, the email 106 may include an indication of a phone number 110, with instructions for the user of receiving device(s) 126 to call and/or engage with the phone number 110. For instance, the email 106 may include a request for a gift card code, wire transfer, and/or salary deposit, a notification regarding a bank account transaction, a list of unpaid invoices, sensitive information, and/or the like. Further, the email 106 may include, along with the request, notification, etc., an indication of the phone number 110 for the user of the receiving device 126 to engage with. As illustrated, the email 106 may appear to be from the user’s bank, include a notification that a certain amount of funds is going to be withdrawn from a user account, as well as the phone number 110 to call if the withdrawal is an error. In some instances, the phone number 110 may be included within the body of the email 106, an attachment to the email 106, URLs included with the email 106, and/or the like.

Additionally, or alternatively, the email security system 104 may be configured to receive and/or extract metadata 114 associated with the phone number (e.g., reputation data). In some examples, the phone number metadata 114 may be received and/or extracted from one or more sources. In some examples, where the phone number metadata 114 is from multiple sources, the phone number metadata 114 may be aggregated and stored at a single location (e.g., a datastore). The phone number metadata 114 may include a call history associated with the phone number (e.g., whether the phone number engages in a large volume of calls), user feedback regarding the phone number, public forums, and/or the like. Based on the phone number metadata 114, the email security system 104 may be configured to determine, and/or identify, a phone number reputation 120 associated with the phone number 110 included in the email 106. For example, based on the phone number metadata 114, the email security system 104 may determine and/or identify a reputation score as part of the phone number reputation 120. For example, the reputation score may be on a scale of -10 to 10, with -10 indicating a negative reputation and 10 indicating a positive reputation. Additionally, or alternatively, based on the phone number metadata 114 and/or the reputation score, the email security system 104 may determine a result based on the reputation score as part of the phone number reputation 120. By way of example, and not limitation, reputation scores between -10 and -6 may be associated with a result of “untrusted,” reputation scores between -5 and 0 may be associated with a result of “suspicious,” reputation scores between 1 and 3 may be associated with a result of “questionable,” reputation scores between 4 and 7 may be associated with a result of “neutral,” and/or reputation scores between 8 and 10 may be associated with a result of “trusted.” However, in other examples, the upper and/or lower bounds for each of the described score ranges could be higher or lower, and/or the score ranges may be larger or smaller. Additionally, or alternatively, based on the phone number metadata 114, the email security system 104 may determine a categorization and/or classification associated with the phone number 110 as part of the phone number reputation 120. The categorization and/or classification may be based on a threat type associated with the phone number 110. For example, the categorization and/or classification may indicate that the phone number 110 is associated with a known spamming company trying to get information, a marketing company sending a large amounts of market materials, malicious attackers, and/or the like.

Upon the determination of the phone number reputation 120 for the phone number 110 included in the email 106, the email security system 104 may be configured to classify the email 106 as a non-callback phishing attempt email or a callback phishing attempt email. For example, the email security system 104 may determine that an email 106 is associated with a malicious intent (e.g., the email 106 is sent from a fake address associated with an IP address in a high-risk geographic location). Additionally, or alternatively, the email security system 104 may determine that the email 106 is associated with a phone number reputation 120 such as a reputation score of -10 and indicating an “untrusted” result. Accordingly, the email security system 104 may classify the email 106 as a callback phishing attempt email. In another example, the email security system 104 may determine that the email 106 is not associated with a malicious intent (e.g., the email 106 is sent from a legitimate address associated with a trusted IP address). Additionally, or alternatively, the email security system 104 may determine that the email 106 is associated with a phone number reputation 120 indicating a reputation score of 10 and indicating a “trusted” result. Accordingly, the email security system 104 may classify the email 106 as a non-callback phishing attempt email.

The determined email intent 118 and/or phone number reputation 120 may be equally weighted or have differing weights when factored together to determine whether to classify the email 106 as a non-callback phishing attempt email or a callback phishing attempt email. For example, despite a lack of a determination of malicious intent associated with the email 106 by the email security system 104, the email security system 104 may still classify the email 106 as a callback phishing attempt email based on the phone number reputation 120.

Based on the classification of the email 106 (e.g., whether the email is a non-callback phishing attempt email or a callback phishing attempt email), the email security system 104 may process the email 106 accordingly. For example, in instances where the email 106 is a non-callback phishing attempt email, the email security system 104 may be configured to forward and/or transmit the email 106 as an allowed email 122 to a receiving device(s) 126 such that the allowed email 122 is delivered to the receiving device(s) 126 user’s inbox. In another example, in instances where the email 106 is a callback phishing attempt email, the email security system 104 may be configured to perform a remedial action 128 with respect to the callback phishing attempt email. Remedial actions may include quarantining, flagging, deleting, and/or dropping the callback phishing attempt email, preventing further communication received from the sender device(s) 102 and/or further communication sharing similarities with the callback phishing attempt email, blocking and/or flagging the callback phishing attempt email, reporting sender device(s) 102 information and/or the phone number to authorities, and/or the like. As illustrated, the email 106 may be treated as a dropped email 124.

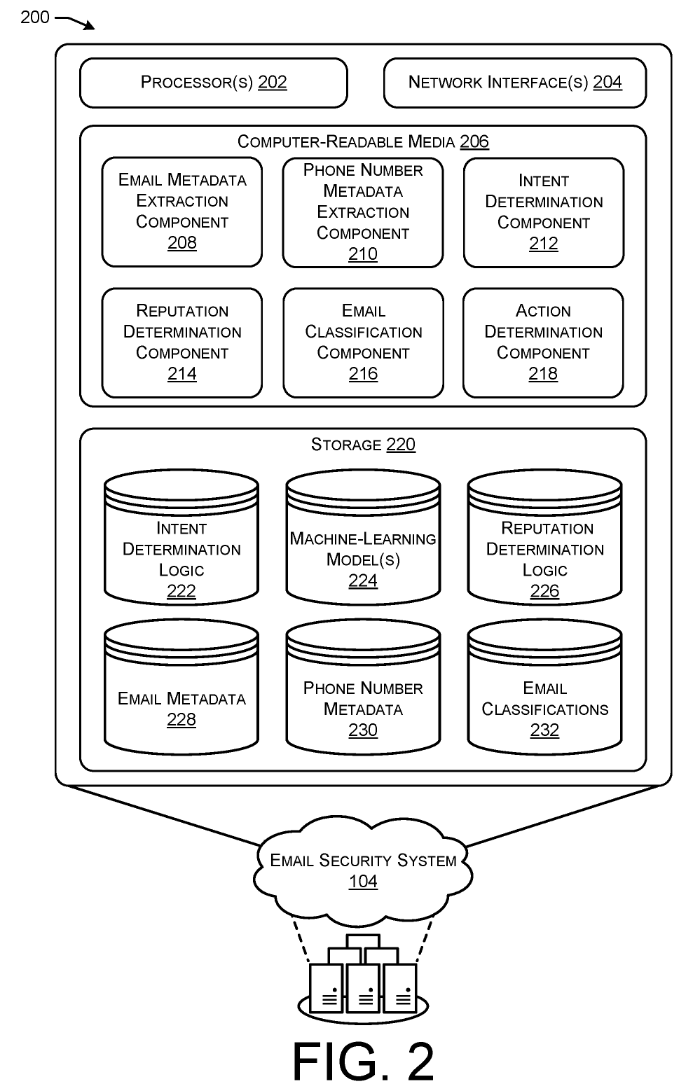

FIG. 2 illustrates a component diagram 200 of an example email security system 104 that uses email intent and phone number reputation to detect a callback phishing attempt included in an email. As illustrated, the email security system 104 may include one or more hardware processors 202 (processors), one or more devices, configured to execute one or more stored instructions. The processor(s) 202 may comprise one or more cores. Further, the email security system 104 may include one or more network interfaces 204 configured to provide communications between the email security system 104 and other devices, such as the sending device(s) 102, receiving devices 126, and/or other systems or devices associated with an email service providing the email communications. The network interfaces 204 may include devices configured to couple to personal area networks (PANs), wired and wireless local area networks (LANs), wired and wireless wide area networks (WANs), and so forth. For example, the network interfaces 204 may include devices compatible with Ethernet, Wi-Fi™, and so forth.

The email security system 104 may also include computer-readable media 206 that stores various executable components (e.g., software-based components, firmware-based components, etc.). The computer-readable media 206 may store components to implement functionality described herein. While not illustrated, the computer-readable media 206 may store one or more operating systems utilized to control the operation of the one or more devices that comprise the email security system 104. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the email security system 104 to perform various operations described herein. For example, an email metadata extraction component 208 may be configured to, when executed by the processor(s) 202, perform various techniques for extracting email metadata (e.g., email information to determine whether an email intent is a malicious email intent). Email metadata may include, for example, indications of email content such as “From-Field” addresses and/or names for the email, “To-Field” addresses for the email, a “Subject” of the email, a Date/Time the email was communicated, hashes of attachments to the email, URLs in the body of the email, IP addresses associated with the email, and/or a domain associated with the email. In some instances, the metadata may additionally, or alternatively, include content included in the body of the email, actual attachments, and/or the like.

The computer-readable media 206 may further include a phone number metadata extraction component 210 that may configure the email security system 104 to perform various operations described herein. For instance, the phone number metadata extraction component 210 may be configured to, when executed by the processor(s) 202, perform various techniques for extracting and/or receiving metadata associated with a phone number included in an email. In some examples, the phone number metadata may be received and/or extracted from one or more sources. In some examples, where the phone number metadata is from multiple sources, the phone number metadata may be aggregated and stored at a single location (e.g., a datastore). The phone number metadata may include a call history associated with the phone number (e.g., whether the phone number engages in a large volume of calls), user feedback regarding the phone number, public forums, and/or the like.

The computer-readable media 206 may further include an intent determination component 212 that may configure the email security system 104 to perform various operations described herein. For instance, the intent determination component 212 may be configured to, when executed by the processor(s) 202, perform various techniques for analyzing email metadata to determine an email intent, such as whether the email intent indicates a malicious email. The intent determination component 212 may utilize policies and/or rules to analyze email metadata to determine if the corresponding email is malicious.

The computer-readable media 206 may further include reputation determination component 214 that may configure the email security system 104 to perform various operations described herein. For instance, the reputation determination component 214 may be configured to, when executed by the processor(s) 202, perform various techniques for analyzing phone number metadata to determine a reputation associated with a phone number. The reputation determination component 214 may utilize policies and/or rules to analyze phone number metadata to determine a phone number reputation (e.g., a reputation score, a result associated with the reputation score, a categorization of the email, and/or the like).

The computer-readable media 206 may further include email classification component 216 that may configure the email security system 104 to perform various operations described herein. For instance, the email classification component 216 may be configured to, when executed by the processor(s) 202, perform various techniques for determining whether an incoming email is associated with a callback phishing attempt or not. For example, the email classification component 216 may utilize policies and/or rules to analyze the email intent and/or phone number reputation to determine if an email is a callback phishing attempt or if the email is a non-callback phishing attempt.

The computer-readable media 206 may further include action determination component 218 that may configure the email security system 104 to perform various operations described herein. For instance, the action determination component 218 may be configured to, when executed by the processor(s) 202, perform various techniques for determining a remedial action associated with an incoming email, or whether to transmit the email to the receiving user. For example, the action determination component 218 may utilize policies and/or rules to determine a remedial action based at least in part on an email being classified as a callback phishing attempt. Additionally, or alternatively, the action determination component 218 may utilize policies and/or rules to determine to transmit, or forward, an incoming email to a receiving user based at least in part on the email being classified as a non-callback phishing attempt.

The above-noted list of components and their respective processes are merely exemplary, and other types of security policies may be used to analyze the email and/or phone number metadata.

Additionally, the email security system 104 may include storage 220 which may comprise one, or multiple, repositories or other storage locations for persistently storing and managing collections of data such as databases, simple files, binary, and/or any other data. The storage 220 may include one or more storage locations that may be managed by one or more storage/database management systems.

As illustrated, the storage 220 may include intent determination logic 222, ML model(s) 224, reputation determination logic 226, email metadata 228, phone number metadata 230, and/or email classifications 232. It should be appreciated that the foregoing list is merely exemplary and the storage 220 may include additional elements that may be apparent to one skilled in the art.

The intent determination logic 222 may include a database of logic for determining an intent associated with an email (e.g., a malicious intent). For example, the intent determination component 212 may reference intent determination logic 222 and/or email metadata 228 in determining an intent associated with an email.

The ML model(s) 224 may include a database of machine learning algorithms. The ML model(s) may include one or more algorithms including supervised, semi-supervised, unsupervised, and/or reinforcement. In some examples, the processor(s) 202 train(s) the email security system 104 utilizing machine learning techniques, statistical analysis, or any other means by which a system may be trained to output a detection of a callback phishing attempt based on input associated with received email information and/or other data associated with the storage 220.

The reputation determination logic 226 may include a database of logic for determining a reputation associated with a phone number included in an email (e.g., reputation score, result based on reputation score, reputation categorization, etc.). For example, the reputation determination component 214 may reference reputation determination logic 226 and/or phone number metadata 230 in determining a reputation associated with a phone number included in an email.

The email metadata 228 may include a database of email metadata (e.g., metadata indicating the content, attributes, and/or other information associated with an email). Email metadata may include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine the intent of the email (e.g., whether the intent is malicious). Additionally, or alternatively, the email metadata 228 may be a database of historically received and/or extracted email metadata.

The phone number metadata 230 may include a database of phone number metadata, which may include a call history associated with the phone number (e.g., whether the phone number engages in a large volume of calls), user feedback regarding the phone number, public forums, and/or the like. The phone number metadata 230 may include any data usable by the reputation determination component 214 to determine a reputation associated with a phone number (e.g., reputation score, result based on reputation score, reputation categorization, etc.). Additionally, or alternatively, the phone number metadata 230 may be a database of historically received and/or extracted phone number metadata 230.

The email classifications 232 may store the results from the email classification component 216, the intent determination component 212, and/or the reputation determination component 214. For example, the email classifications 232 may be a database of historically classified emails (e.g., whether the email is classified as a callback phishing attempt or a non-callback phishing attempt). As such, the email classifications 232 may be used by the email classification component 216 during its operation (e.g., in determining subsequent email classifications) and/or the action determination component 218 during its operation (e.g., in determining an action to perform with respect to a classified email).

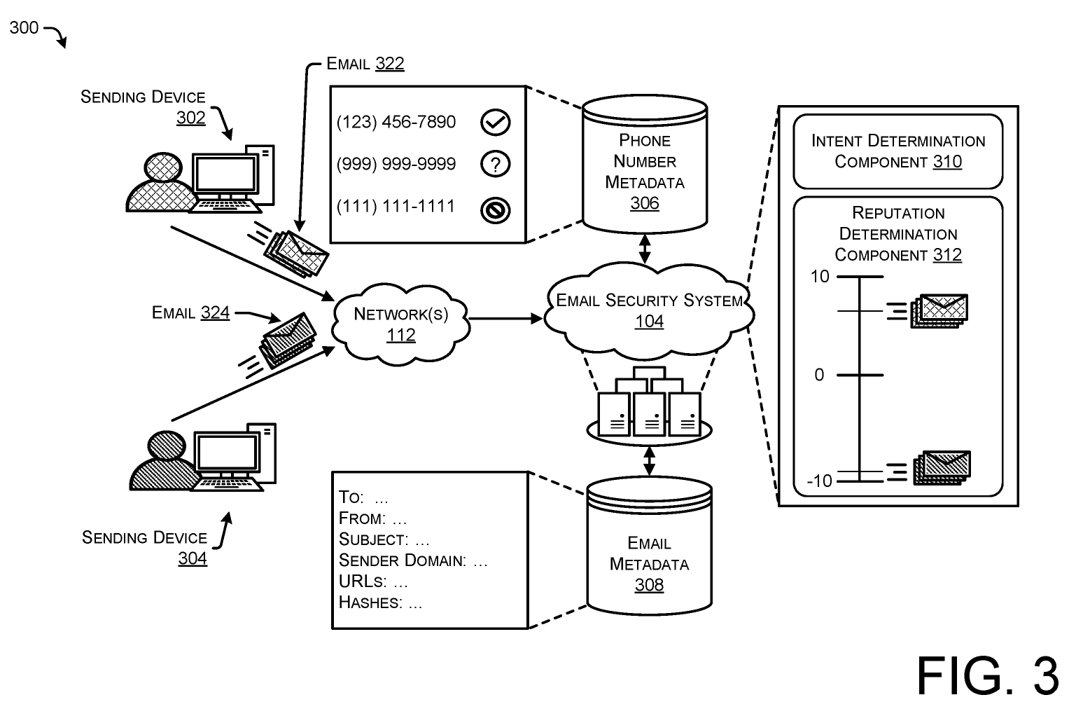

FIG. 3 illustrates a flow diagram of an example process 300 for determining email intent and phone number reputation for a phone number included in the email.

As illustrated, sending devices, such as sending device 302 and/or sending device 304, may send an email, such as email 322 and/or email 324, via network(s) 112 to be delivered to a receiving user. The email security system 104 may receive, or intercept, email 322 and/or email 324, and may be configured to extract email metadata 308 associated with the email 322 and/or email 324. Email metadata 308 may include, for example, indications of “To-Field” addresses for the email, “From-Field” addresses for the email, a “Subject” of the email, a sender domain, URLs in the body of the email, hashes of attachments to the email, and/or the like. The email security system 104 may use, or work in combination with, intent determination component 310 to determine the intent of an incoming email, such as email 322 and/or email 324, based on the email metadata 308, and in turn, whether the email is potentially malicious. The email metadata 308 may be processed using security analysis techniques to determine whether the email is a scam email, phishing email, and/or other malicious email (e.g., the intent).

Additionally, or alternatively, email 322 and/or email 324 may include an indication of a phone number with instructions for a receiving user to engage with. Accordingly, the email security system 104 may be configured to receive and/or extract phone number metadata 306 associated with the phone number. The phone number metadata 306 may include a call history associated with the phone number (e.g., whether the phone number engages in a large volume of calls), user feedback regarding the phone number, public forums, and/or the like. By way of example, and not limitation, email 322 may include a phone number of (123) 456-7890 with instructions for the receiving user to call the phone number. Additionally, or alternatively, the phone number metadata 306 may indicate that the phone number is a legitimate phone number (e.g., legitimately associated with the entity sending the email 322). In another example, email 324 may include a phone number of (111) 111-1111 with instructions for the receiving user to call the phone number. Additionally, or alternatively, the phone number metadata 306 may indicate that the phone number is a fraudulent phone number (e.g., associated with a large volume of calls). While emails 322 and 324 are illustrated as including phone numbers with a North American Numbering Plan (NANP) (e.g., three-digit area code, seven-digit subscriber number, etc.), other conventions and/or formats for phone numbers may be used (e.g., 01 11111111, +123456 789101, etc.).

Based on the phone number metadata 306, the email security system 104 may use, or work in combination with, reputation determination component 312 determine, and/or identify, a reputation associated with the phone number included in the email 322 and/or email 324. For example, based on the phone number metadata 306, the email security system 104 and/or reputation determination component 312 may determine and/or identify a reputation score. For example, the reputation score may be on a scale of -10 to 10, with -10 indicating a negative reputation and 10 indicating a positive reputation. As illustrated, email security system 104 and/or reputation determination component 312 may determine that the phone number included in email 322, based on the phone number metadata 306, has a reputation score of 7. In another example, email security system 104 and/or reputation determination component 312 may determine that the phone number included in email 324, based on the phone number metadata 306, has a reputation score of -9. Additionally, or alternatively, based on the phone number metadata and/or the reputation score, the email security system 104 and/or reputation determination component 312 may determine a result based on the reputation score. By way of example, and not limitation, reputation scores between -10 and -6 may be associated with a result of “untrusted,” reputation scores between -5 and 0 may be associated with a result of “suspicious,” reputation scores between 1 and 3 may be associated with a result of “questionable,” reputation scores between 4 and 7 may be associated with a result of “neutral,” and/or reputation scores between 8 and 10 may be associated with a result of “trusted.” Accordingly, phone number included in email 322 may be associated with a result of “neutral,” whereas the phone number included in the email 324 may be associated with the result of “untrusted.”

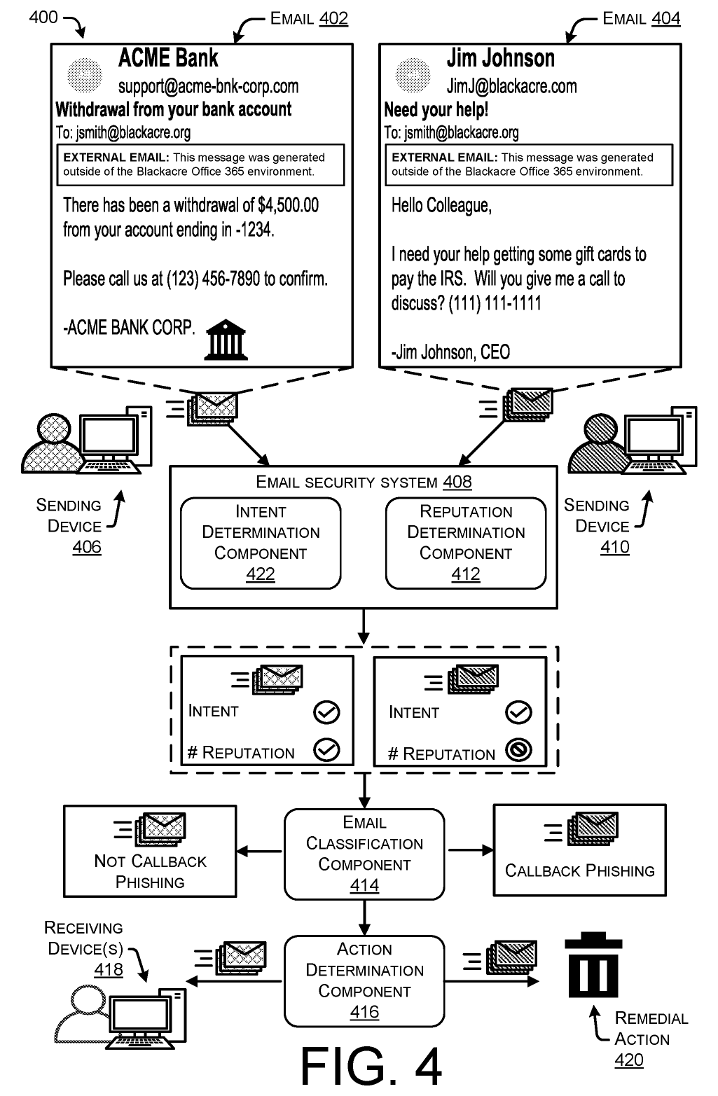

FIG. 4 illustrates an example environment 400 in which the email security system 408 (and/or email security system 104) uses email intent and phone number reputation to detect callback phishing in incoming emails.

As illustrated, an email security system 408 may receive an email, such as email 402 and/or email 404, from a sending device, such as sending device 406 and/or sending device 410. As described in more detail above, the email security system 408 may use, or work in combination with, an intent determination component 422 and/or reputation determination component 412 to determine an intent and phone number reputation associated with an email. For example, email metadata associated with email 402 may indicate that the email 402 is not associated with a malicious intent (e.g., the “From-Field” address for the email 402 is legitimate, the body of the email 402 is written similarly to other emails from ACME Bank, etc.). Additionally, or alternatively, phone number metadata associated with the email 402 may indicate that the phone number has a trustworthy reputation (e.g., associated with a high reputation score). In another example, email metadata associated with email 404 may indicate that the email 404 is associated with malicious intent (e.g., the “From-Field” address for the email 404 has an incorrect domain, the body of the email 404 contains subject matter indicate of malicious intent, the email 404 is indicated as being an external email despite allegedly being from a colleague, etc.). Additionally, or alternatively, phone number metadata associated with the email 404 may indicate that the phone number has an untrustworthy reputation (e.g., associated with a low reputation score).

Upon the determination of the email intent and/or reputation associated with the phone number included in the email 402 and/or email 404, the email security system 408 may use, or work in combination with email classification component 414 to classify the email 402 and/or email 404 as a non-callback phishing attempt email or a callback phishing attempt email. For example, as described above, email 402 may not be associated with a malicious intent, and phone number metadata associated with the email 402 may indicate that the phone number has a trustworthy reputation. Accordingly, the email classification component 414 may be configured to determine that the email 402 is a non-callback phishing attempt email. In another example, as described above, email 402 may be associated with a malicious intent, and phone number metadata associated with the email 404 may indicate that the phone number has an untrustworthy reputation. Accordingly, the email classification component 414 may be configured to determine that the email 404 is a callback phishing attempt email.

Based on the classification of the email 402 and/or email 404 (e.g., whether the email is a non-callback phishing attempt email or a callback phishing attempt email), the email security system may process the email accordingly. For example, in instances where the email 402 is a non-callback phishing attempt email, the email security system may use, or work in combination with, the action determination component 416 to forward and/or transmit the email 402 to receiving device(s) 418. In instances where the email 404 is a callback phishing attempt email, the email security system 408 may use, or work in combination with, the action determination component 416 to perform a remedial action 420 with respect to the email 404. Remedial actions 420 may include quarantining, flagging, deleting, and/or dropping the email 404 preventing further communication received from the sending device 410 and/or further communication sharing similarities with the email 404, blocking and/or flagging the email 404, reporting sending device 410 information and/or the phone number to authorities, and/or the like.

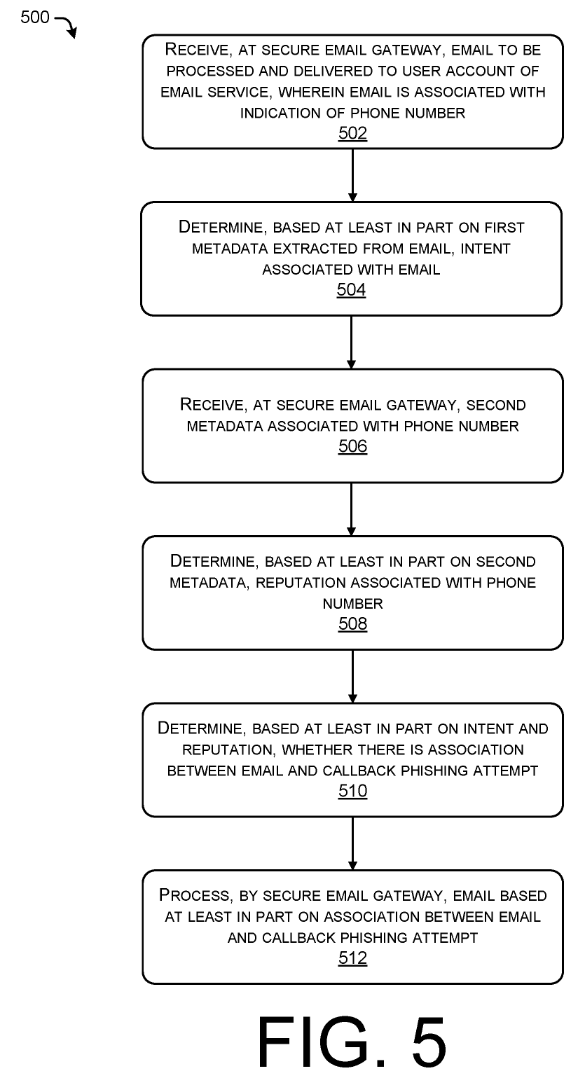

FIG. 5 illustrates a flow diagram of an example process 500 for detecting callback phishing in incoming emails. The techniques may be applied by a system comprising one or more processors, and one or more non-transitory computer-readable media storing computer-executable instructions that, when executed by the one or more processors, cause the one or more processors to perform operations of process 500.

The processes described herein are illustrated as collections of blocks in logical flow diagrams, which represent a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

At block 502, the process 500 may include receiving, at a secure email gateway, an email to be processed and delivered to a user account of an email service, wherein the email is associated with an indication of a phone number. For example, to implement the techniques described herein, an email service platform may use, or work in combination with, an email security system. The email security system (e.g., a SEG), may receive, or intercept, emails and/or other types of electronic communications that are to be communicated to users of the email service platform, such as being stored at a location that is accessible to the users via their respective inboxes. In some examples, the email received, or intercepted, by the email security system may be designed to engage the receiving user in a callback phishing attack. In other words, the email may include an indication of a phone number, with instructions for the receiving user to call and/or engage with the phone number. For instance, the email may include a request for a gift card code, wire transfer, and/or salary deposit, a notification regarding a bank account transaction, a list of unpaid invoices, sensitive information, and/or the like. Further, the email may include, along with the request, notification, etc., an indication of the phone number for the user to engage with. For example, the email may appear to be from the receiving user’s bank, include a notification that a certain amount of funds is going to be withdrawn from a user account, as well as a phone number to call if the withdrawal is an error. In some instances, the phone number may be included within the body of the email, an attachment to the email, URLs included with the email, and/or the like.

At block 504, the process 500 may include determining, based at least in part on first metadata extracted from the email, an intent associated with the email. For example, after receiving an email for a user (e.g., a receiving user) of the email service platform, the email security system may be configured to extract email metadata associated with the email. Email metadata may include, for example, indications of “From-Field” addresses and/or names for the email, “To-Field” addresses for the email, a “Subject” of the email, a Date/Time the email was communicated, hashes of attachments to the email, URLs in the body of the email, Internet Protocol (IP) addresses associated with the email, and/or a domain associated with the email (e.g., the email server associated with an email address). In some instances, the metadata may additionally, or alternatively, include content included in the body of the email, actual attachments to the email, and/or other data of the email. Further, the metadata extracted from the email may generally be any probative information for the email security system to determine the intent of the email (e.g., whether the intent is malicious).

The email security system may be configured to determine the intent of an incoming email based on the email metadata, and in turn, whether the email is potentially malicious. The email metadata may be processed using security analysis techniques to determine whether the email is a scam email, phishing email, and/or other malicious email (e.g., the intent). For example, the email security system may determine that the email was sent from an email address associated with a malicious domain, the subject includes words commonly associated with phishing, spam, and/or spoofing attacks, URLs included in the email are to malicious websites, hashes of attachments correspond to malware attacks, and so forth. The determination of the intent of the email may be represented as a general result (e.g., potentially malicious, safe, unknown, etc.), a probability score indicative of a likelihood of a malicious intent, and/or the like.

At block 506, the process 500 may include receiving, at the secure email gateway, second metadata associated with the phone number. For example, the email security system may be configured to receive and/or extract metadata associated with the phone number (e.g., reputation data). In some examples, the phone number metadata may be received and/or extracted from one or more sources. In some examples, where the phone number metadata is from multiple sources, the phone number metadata may be aggregated and stored at a single location (e.g., a datastore). The phone number metadata may include a call history associated with the phone number (e.g., whether the phone number engages in a large volume of calls), user feedback regarding the phone number, public forums, and/or the like.

At block 508, the process 500 may include determining, based at least in part on the second metadata, a reputation associated with the phone number. For example, based on the phone number metadata, the email security system may be configured to determine, and/or identify, a reputation associated with the phone number included in the email. For example, based on the phone number metadata, the email security system may determine and/or identify a reputation score. For example, the reputation score may be on a scale of -10 to 10, with -10 indicating a negative reputation and 10 indicating a positive reputation. Additionally, or alternatively, based on the phone number metadata and/or the reputation score, the email security system may determine a result based on the reputation score. By way of example, and not limitation, reputation scores between -10 and -6 may be associated with a result of “untrusted,” reputation scores between -5 and 0 may be associated with a result of “suspicious,” reputation scores between 1 and 3 may be associated with a result of “questionable,” reputation scores between 4 and 7 may be associated with a result of “neutral,” and/or reputation scores between 8 and 10 may be associated with a result of “trusted.” However, in other examples, the upper and/or lower bounds for each of the described score ranges could be higher or lower, and/or the score ranges may be larger or smaller. Additionally, or alternatively, based on the phone number metadata, the email security system may determine a categorization and/or classification associated with the phone number. The categorization and/or classification may be based on a threat type associated with the phone number. For example, the categorization and/or classification may indicate that the phone number is associated with a known spamming company trying to get information, a marketing company sending a large amounts of market materials, malicious attackers, and/or the like.

At block 510, the process 500 may include determining, based at least in part on the intent and the reputation, whether there is an association between the email and a callback phishing attempt. For example, the email security system may be configured to classify the email as a non-callback phishing attempt email or a callback phishing attempt email. For example, the email security system may determine that an email is associated with a malicious intent (e.g., the email is sent from a fake address associated with an IP address in a high-risk geographic location). Additionally, or alternatively, the email security system may determine that the email is associated with a reputation score of -10 and indicating an “untrusted” result. Accordingly, the email security system may classify the email as a callback phishing attempt email. In another example, the email security system may determine that the email is not associated with a malicious intent (e.g., the email is sent from a legitimate address associated with a trusted IP address). Additionally, or alternatively, the email security system may determine that the email is associated with a reputation score of 10 and indicating a “trusted” result. Accordingly, the email security system may classify the email as a non-callback phishing attempt email.

At block 512, the process 500 may include processing, by the secure email gateway, the email based at least in part on the association between the email and the callback phishing attempt. For example, based on the classification of the email (e.g., whether the email is a non-callback phishing attempt email or a callback phishing attempt email), the email security system may process the incoming email accordingly. For example, in instances where the email is a non-callback phishing attempt email, the email security system may be configured to forward and/or transmit the email to a receiving user such that the email is delivered to the receiving user’s inbox. In another example, in instances where the email is a callback phishing attempt email, the email security system may be configured to perform a remedial action with respect to the callback phishing attempt email. Remedial actions may include quarantining, flagging, deleting, and/or dropping the callback phishing attempt email, preventing further communication received from the sender and/or further communication sharing similarities with the callback phishing attempt email, blocking and/or flagging the callback phishing attempt email, reporting sender information and/or the phone number to authorities, and/or the like.

Additionally, or alternatively, the process 500 may include wherein processing the email based at least in part on the association with the email and the callback phishing attempt includes refraining from transmitting the email to the user account.

Additionally, or alternatively, the process 500 may include, wherein the email is a first email and the phone number is a first phone number, receiving, at the secure email gateway, a second email to be processed and delivered to the user account of the email service, wherein the second email includes an indication of a second phone number, determining, based at least in part on first metadata extracted from the second email, an intent associated with the second email, and receiving, at the secure email gateway, second metadata associated with the second phone number. The process 500 may further include determining, based at least in part on the second metadata, a reputation associated with the second phone number, determining, based at least in part on the intent and the reputation, whether there is an association between the second email and a callback phishing attempt, and transmitting, by the secure email gateway, the second email to the user account based at least in part on an absence of the association between the second email and the callback phishing attempt.

Additionally, or alternatively, the process 500 may include wherein the reputation includes at least one of a reputation score or a threat type categorization.

Additionally, or alternatively, the process 500 may include wherein determining, based at least in part on the first metadata extracted from the email, the intent associated with the email comprises one or more of analyzing a subject of the email, analyzing contents of the email, analyzing a sender addresses associated with the email, analyzing an Internet Protocol (IP) address associated with the email, and/or analyzing a domain associated with the email.

Additionally, or alternatively, the process 500 may include determining, based at least in part on the first metadata extracted from the email, a context associated with the email, and determining, based at least in part on the context, a weight to be applied to the reputation, wherein determining whether there is the association between the email and the callback phishing attempt is based at least in part on the weighted reputation.

Additionally, or alternatively, the process 500 may include wherein the second metadata includes an aggregation of second metadata from one or more reputation sources.

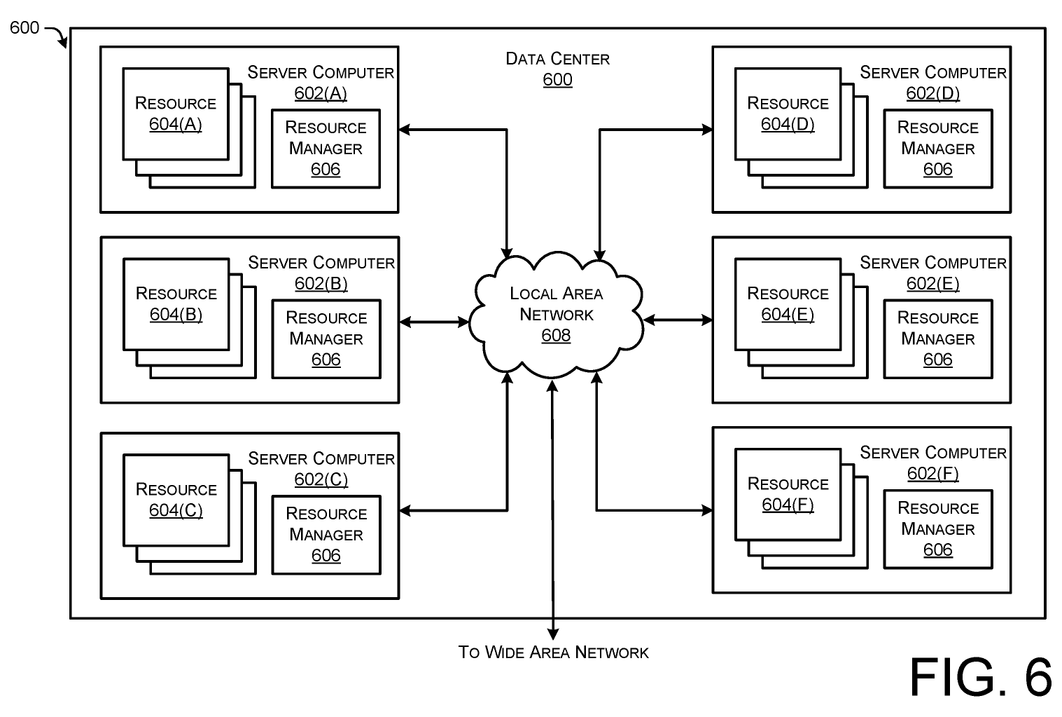

FIG. 6 is a computing system diagram illustrating a configuration for a data center 600 that can be utilized to implement aspects of the technologies disclosed herein. In one example, the data center 600 may be used to support the email security system 104 and/or the service provider network 132. The example data center 600 shown in FIG. 6 includes several server computers 602A-602F (which might be referred to herein singularly as “a server computer 602” or in the plural as “the server computers 602”) for providing computing resources. In some examples, the resources and/or server computers 602 may include, or correspond to, the any type of networked device described herein. Although described as servers, the server computers 602 may comprise any type of networked device, such as servers, switches, routers, hubs, bridges, gateways, modems, repeaters, access points, etc.

The server computers 602 can be standard tower, rack-mount, or blade server computers configured appropriately for providing computing resources. In some examples, the server computers 602 may provide computing resources 604 including data processing resources such as VM instances or hardware computing systems, database clusters, computing clusters, storage clusters, data storage resources, database resources, networking resources, and others. Some of the server computers 602 can also be configured to execute a resource manager 606 capable of instantiating and/or managing the computing resources. In the case of VM instances, for example, the resource manager 606 can be a hypervisor or another type of program configured to enable the execution of multiple VM instances on a single server computer 602. Server computers 602 in the data center 600 can also be configured to provide network services and other types of services. In one example, server computers 602 may be used to support the email security system 104 and/or the service provider network 132.

In the example data center 600 shown in FIG. 6, an appropriate LAN 608 is also utilized to interconnect the server computers 602A-602F. It should be appreciated that the configuration and network topology described herein has been greatly simplified and that many more computing systems, software components, networks, and networking devices can be utilized to interconnect the various computing systems disclosed herein and to provide the functionality described above. Appropriate load balancing devices or other types of network infrastructure components can also be utilized for balancing a load between data centers 600, between each of the server computers 602A-602F in each data center 600, and, potentially, between computing resources in each of the server computers 602. It should be appreciated that the configuration of the data center 600 described with reference to FIG. 6 is merely illustrative and that other implementations can be utilized.

In some examples, the server computers 602 may each execute one or more application containers and/or virtual machines to perform techniques described herein.

In some instances, the data center 600 may provide computing resources, like application containers, VM instances, and storage, on a permanent or an as-needed basis. Among other types of functionality, the computing resources provided by a cloud computing network may be utilized to implement the various services and techniques described above. The computing resources 604 provided by the cloud computing network can include various types of computing resources, such as data processing resources like application containers and VM instances, data storage resources, networking resources, data communication resources, network services, and the like.

Each type of computing resource 604 provided by the cloud computing network can be general-purpose or can be available in a number of specific configurations. For example, data processing resources can be available as physical computers or VM instances in a number of different configurations. The VM instances can be configured to execute applications, including web servers, application servers, media servers, database servers, some or all of the network services described above, and/or other types of programs. Data storage resources can include file storage devices, block storage devices, and the like. The cloud computing network can also be configured to provide other types of computing resources 604 not mentioned specifically herein.

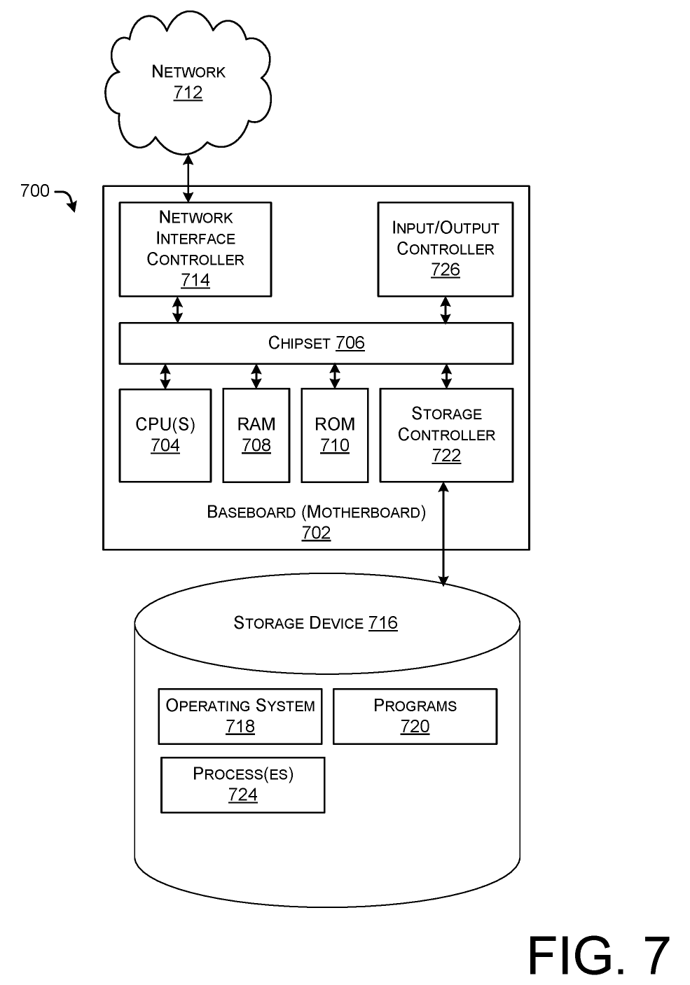

The computing resources 604 provided by a cloud computing network may be enabled in one embodiment by one or more data centers 600 (which might be referred to herein singularly as “a data center 600” or in the plural as “the data centers 600”). The data centers 600 are facilities utilized to house and operate computer systems and associated components. The data centers 600 typically include redundant and backup power, communications, cooling, and security systems. The data centers 600 can also be located in geographically disparate locations. One illustrative embodiment for a data center 600 that can be utilized to implement the technologies disclosed herein will be described below with regard to FIG. 7.

FIG. 7 shows an example computer architecture for a server computer 700 capable of executing program components for implementing the functionality described above. The computer architecture shown in FIG. 7 illustrates a conventional server computer, workstation, desktop computer, laptop, tablet, network appliance, e-reader, smartphone, or other computing device, and can be utilized to execute any of the software components presented herein. The server computer 700 may, in some examples, correspond to a network node described herein.

The computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPUs 704 can be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPUs 704 and the remainder of the components and devices on the baseboard 702. The chipset 706 can provide an interface to a random-access memory (RAM) 708, used as the main memory in the computer 700. The chipset 706 can further provide an interface to a computer-readable storage medium such as a read-only memory (ROM) 710 or non-volatile RAM (NVRAM) for storing basic routines that help to startup the computer 700 and to transfer information between the various components and devices. The ROM 710 or NVRAM can also store other software components necessary for the operation of the computer 700 in accordance with the configurations described herein.

The computer 700 can operate in a networked environment using logical connections to remote computing devices and computer systems through a network, such as the network 712. The chipset 706 can include functionality for providing network connectivity through a network interface controller (NIC) 714, such as a gigabit Ethernet adapter. The NIC 714 is capable of connecting the computer 700 to other computing devices over the network 712. It should be appreciated that multiple NICs 714 can be present in the computer 700, connecting the computer 700 to other types of networks and remote computer systems. In some instances, the NICs 714 may include at least on ingress port and/or at least one egress port.

The computer 700 can be connected to a storage device 716 that provides non-volatile storage for the computer. The storage device 716 can store an operating system 718, programs 720, and data, which have been described in greater detail herein. The storage device 716 can be connected to the computer 700 through a storage controller 722 connected to the chipset 706. The storage device 716 can consist of one or more physical storage units. The storage controller 722 can interface with the physical storage units through a serial attached small computer system interface (SCSI) (SAS) interface, a serial advanced technology attachment (SATA) interface, a fiber channel (FC) interface, or other type of interface for physically connecting and transferring data between computers and physical storage units.

The computer 700 can store data on the storage device 716 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 716 is characterized as primary or secondary storage, and the like.

For example, the computer 700 can store information to the storage device 716 by issuing instructions through the storage controller 722 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 can further read information from the storage device 716 by detecting the physical states or characteristics of one or more particular locations within the physical storage units.

In addition to the mass storage device 716 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by any network node described herein may be supported by one or more devices similar to computer 700. Stated otherwise, some or all of the operations performed by a network node may be performed by one or more computer devices 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 716 can store an operating system 718 utilized to control the operation of the computer 700. According to one embodiment, the operating system comprises the LINUXTM operating system. According to another embodiment, the operating system includes the WINDOWSTM SERVER operating system from MICROSOFT Corporation of Redmond, Washington. According to further embodiments, the operating system can comprise the UNIXTM operating system or one of its variants. It should be appreciated that other operating systems can also be utilized. The storage device 716 can store other system or application programs and data utilized by the computer 700.

In one embodiment, the storage device 716 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The computer 700 can also include computer-readable storage media having instructions stored thereupon for performing any of the other computer-implemented operations described herein.

As illustrated in FIG. 7, the storage device 716 stores programs 720, which may include one or more processes 724. The process(es) 724 may include instructions that, when executed by the CPU(s) 704, cause the computer 700 and/or the CPU(s) 704 to perform one or more operations.

The computer 700 can also include at least one input/output controller 726 for receiving and processing input from a number of input devices, such as a keyboard, a mouse, a touchpad, a touch screen, an electronic stylus, or other type of input device. Similarly, an input/output controller 726 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.” As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving, at a secure email gateway, an email to be processed and delivered to a user account of an email service, wherein the email is associated with an indication of a phone number;
determining, based at least in part on first metadata extracted from the email, an intent associated with the email;
receiving, at the secure email gateway, second metadata associated with the phone number;
determining, based at least in part on the second metadata, a reputation associated with the phone number;
determining, based at least in part on the intent and the reputation, whether there is an association between the email and a callback phishing attempt; and
processing, by the secure email gateway, the email based at least in part on the association between the email and the callback phishing attempt.

2. The method of claim 1, wherein processing the email based at least in part on the association with the email and the callback phishing attempt includes refraining from transmitting the email to the user account.

3. The method of claim 1, wherein the email is a first email and the phone number is a first phone number, the method further comprising:
receiving, at the secure email gateway, a second email to be processed and delivered to the user account of the email service, wherein the second email includes an indication of a second phone number;
determining, based at least in part on first metadata extracted from the second email, an intent associated with the second email;
receiving, at the secure email gateway, second metadata associated with the second phone number;
determining, based at least in part on the second metadata, a reputation associated with the second phone number;
determining, based at least in part on the intent and the reputation, whether there is an association between the second email and a callback phishing attempt; and
transmitting, by the secure email gateway, the second email to the user account based at least in part on an absence of the association between the second email and the callback phishing attempt.

4. The method of claim 1, wherein the reputation includes at least one of a reputation score or a threat type categorization.

5. The method of claim 1, wherein determining, based at least in part on the first metadata extracted from the email, the intent associated with the email comprises one or more of:
analyzing a subject of the email;
analyzing contents of the email;
analyzing a sender address associated with the email;
analyzing an Internet Protocol (IP) address associated with the email; or
analyzing a domain associated with the email.

6. The method of claim 1, further comprising:
determining, based at least in part on the first metadata extracted from the email, a context associated with the email; and
determining, based at least in part of the context, a weight to be applied to the reputation,
wherein determining whether there is the association between the email and the callback phishing attempt is based at least in part on the weighted reputation.

7. The method of claim 1, wherein the second metadata includes an aggregation of second metadata from one or more reputation sources.

8. An email security system comprising:
one or more processors; and
one or more non-transitory computer-readable media storing computer-executable instructions that, when executed by the one or more processors, cause the email security system to perform operations comprising:
receiving an email to be processed and delivered to a user account of a communication service, wherein the email is associated with an indication of a phone number;
determining, based at least in part on first metadata extracted from the email, an intent associated with the email;
receiving second metadata associated with the phone number; determining, based at least in part on the second metadata, a reputation associated with the phone number;
determining, based at least in part on the intent and the reputation, whether there is an association between the email and a callback phishing attempt; and
processing the email based at least in part on the association between the email and the callback phishing attempt.

9. The email security system of claim 8, wherein processing the email based at least in part on the association with the email and the callback phishing attempt includes refraining from transmitting the email to the user account.

10. The email security system of claim 8, wherein the email is a first email and the phone number is a first phone number, the operations further comprising:
receiving a second email to be processed and delivered to the user account of an email service, wherein the second email includes an indication of a second phone number;
determining, based at least in part on first metadata extracted from the second email, an intent associated with the second email;
receiving second metadata associated with the second phone number;
determining, based at least in part on the second metadata, a reputation associated with the second phone number;
determining, based at least in part on the intent and the reputation, whether there is an association between the second email and a callback phishing attempt; and
transmitting the second email to the user account based at least in part on an absence of the association between the second email and the callback phishing attempt.

11. The email security system of claim 8, wherein the reputation includes at least one of a reputation score or a threat type categorization.

12. The email security system of claim 8, wherein determining, based at least in part on the first metadata extracted from the email, the intent associated with the email comprises one or more of:
analyzing a subject of the email;
analyzing contents of the email;
analyzing a sender address associated with the email;
analyzing an Internet Protocol (IP) address associated with the email; or
analyzing a domain associated with the email.

13. The email security system of claim 8, the operations further comprising:
determining, based at least in part on the first metadata extracted from the email, a context associated with the email; and
determining, based at least in part of the context, a weight to be applied to the reputation,
wherein determining whether there is the association between the email and the callback phishing attempt is based at least in part on the weighted reputation.

14. The email security system of claim 8, wherein the second metadata includes an aggregation of second metadata from one or more reputation sources.

15. One or more non-transitory computer-readable media storing computer-executable instructions that, when executed by one or more processors, cause the one or more processors to perform operations comprising:
receiving an electronic communication to be processed and delivered to a user account of a communication service, wherein the electronic communication is associated with an indication of a phone number;
determining, based at least in part on first metadata extracted from the electronic communication, an intent associated with the electronic communication;
receiving second metadata associated with the phone number;
determining, based at least in part on the second metadata, a reputation associated with the phone number;
determining, based at least in part on the intent and the reputation, whether there is an association between the electronic communication and a callback phishing attempt; and
processing the electronic communication based at least in part on the association between the electronic communication and the callback phishing attempt.

16. The one or more non-transitory computer-readable media of claim 15, wherein processing the electronic communication based at least in part on the association with the electronic communication and the callback phishing attempt includes refraining from transmitting the electronic communication to the user account.

17. The one or more non-transitory computer-readable media of claim 15, wherein the electronic communication is a first electronic communication and the phone number is a first phone number, the operations further comprising:
receiving a second electronic communication to be processed and delivered to the user account of an electronic communication service, wherein the second electronic communication includes an indication of a second phone number;
determining, based at least in part on first metadata extracted from the second electronic communication, an intent associated with the second electronic communication;
receiving second metadata associated with the second phone number;
determining, based at least in part on the second metadata, a reputation associated with the second phone number;
determining, based at least in part on the intent and the reputation, whether there is an association between the second electronic communication and a callback phishing attempt; and
transmitting the second electronic communication to the user account based at least in part on an absence of the association between the second electronic communication and the callback phishing attempt.

18. The one or more non-transitory computer-readable media of claim 15, wherein the reputation includes at least one of a reputation score or a threat type categorization.

19. The one or more non-transitory computer-readable media of claim 15, wherein determining, based at least in part on the first metadata extracted from the electronic communication, the intent associated with the electronic communication comprises one or more of:
analyzing a subject of the electronic communication;
analyzing contents of the electronic communication;
analyzing a sender address associated with the electronic communication;
analyzing an Internet Protocol (IP) address associated with the electronic communication; or
analyzing a domain associated with the electronic communication.

20. The one or more non-transitory computer-readable media of claim 15, the operations further comprising:
determining, based at least in part on the first metadata extracted from the electronic communication, a context associated with the electronic communication; and
determining, based at least in part of the context, a weight to be applied to the reputation,
wherein determining whether there is the association between the electronic communication and the callback phishing attempt is based at least in part on the weighted reputation.
